(19) United States
(12) Patent Application Publication
(10) Pub. No.: US 2021/0185907 A1
(43) Pub. Date: Jun. 24, 2021

(54) SICKLE BAR CUTTER REPLACEMENT BLADE

(71) Applicant: TIM LENNON, Barnum, IA (US)

(72) Inventor: TIM LENNON, Barnum, IA (US)

(21) Appl. No.: 16/725,379

(22) Filed: Dec. 23, 2019

(51) Int. Cl. A01D 34/14; A01D 45/22

(52) U.S. Cl. CPC A01D 34/145; A01D 45/22

(57) ABSTRACT

A replacement blade for a sickle bean harvester, having a flat base, an axis of movement, and a base plane, and attaches to a sickle bar in at least four blade positions. The blade includes four teeth extending in a direction perpendicular to the axis with a triangular shape where the first side extends at an angle from the base and includes a first cutting surface on a first cutting plane that is oblique from the base plane and a first series of cutting edges within the first cutting surface, and the second side extends at an angle from the base and meets the first side at a point, with a second cutting surface on a second cutting plane that is oblique from the base plane, and has a second series of cutting edges within the second cutting surface, and the third side is integral with and abuts the base.

### BACKGROUND

On a harvester with a sickle bar cutter system, the internal stresses on the sickle bar can induce the sickle bar to break. This break is usually between the blades that are attached to the bar of the sickle bar assembly. Replacement of the sickle bar can be time-consuming, costly, or both. A relatively quick and easy repair of the sickle bar is needed in the field.

### SUMMARY

One aspect of the present disclosure includes a replacement blade for a sickle bean harvester, having a base of a substantially flat sheet of metal, an axis of movement, and a base plane, and attaches to a sickle bar in at least four blade positions. The replacement blade includes a series of four teeth extending from the base in a direction perpendicular to the axis of movement, and have a triangular shape where the first side extends in an oblique angle from the base and includes a first cutting surface on a first cutting plane that is oblique from the base plane, with a first series of cutting edges within the first cutting surface, and the second side extends in an oblique angle from the base and meets the first side at a point, with a second cutting surface on a second cutting plane that is oblique from the base plane, and has a second series of cutting edges within the second cutting surface, and the third side is integral with and abuts the base.

Another aspect of the present disclosure includes a cutting blade for attachment to an agricultural implement, having at least eight connection holes extending along a movement axis, at least four cutting blades, each cutting blade comprising a first cutting surface and a second cutting surface, the first and second cutting surfaces extending at an angle from the movement axis and further comprising a plurality of cutting edges, and the connection holes attach to sickle bar in at least four blade positions.

Yet another aspect of the present disclosure includes a method of repairing a sickle bar on an agricultural implement having the steps of removing a sickle bar having two-tooth blades from an agricultural implement, the sickle bar being broken between two of the plurality of two-tooth blades, removing a first two-tooth blade from a first side of a break in the sickle bar, removing a second two-tooth blade from a second side of a break in the sickle bar, and rejoining the broken sickle bar by attaching a four-tooth blade to the sickle bar such that a first pair of teeth on the four-tooth blade are on the first side of the break in the sickle bar, and a second pair of teeth on the four-tooth blade are on the second side of the break in the sickle bar.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a is a diagram showing a prior art cutter or sickle bar assembly.

FIG. 2 is a cross-sectional view of the prior art cutter or sickle bar assembly.

FIG. 3 is a schematic representation of a break in a prior art cutter or sickle bar assembly.

FIG. 4 is a top view of an embodiment of a replacement blade.

FIG. 5 is a schematic representation of a front view of an embodiment of a replacement blade.

FIG. 6 is another top view of an embodiment of a replacement blade.

### DETAILED DESCRIPTION

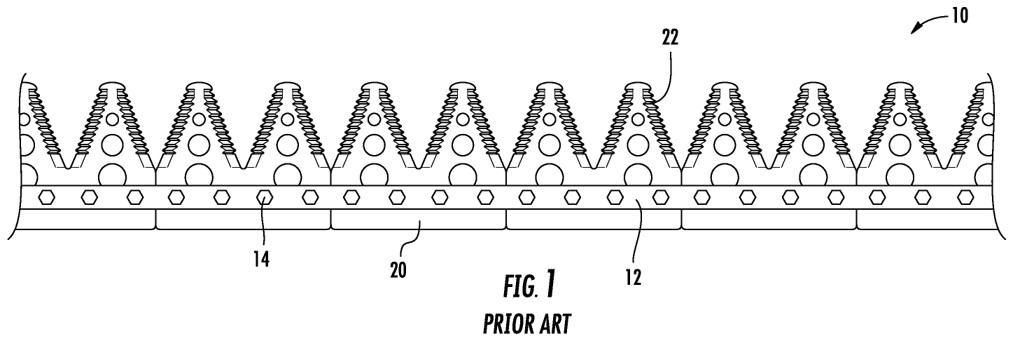

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

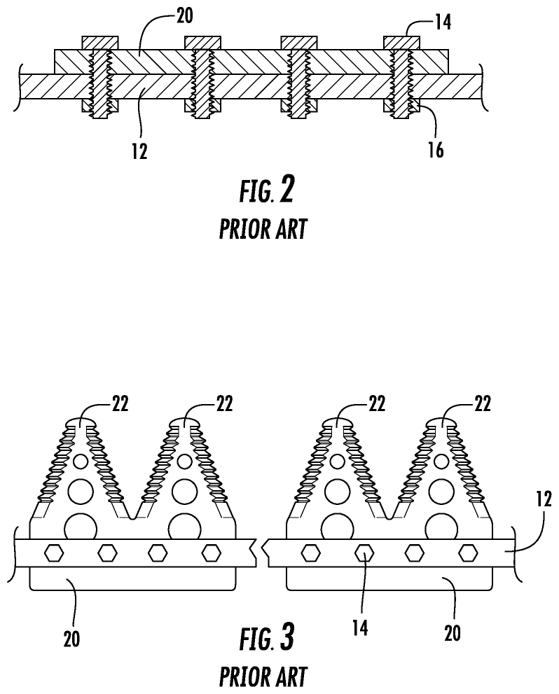

In a typical sickle bean harvester, the harvester, typically a combine, is driven through a field that has been planted with the crop that is ready to be harvested. The combine may have fingers that protrude out of the front side, typically between the rows of the crops. Underneath these fingers, a cutter or cutters like that shown in FIGS. 1-3 traps the crops between the cutters and the fingers. The cutters and fingers shear the crops, usually with the useful portions of the crops at the top being sent back into the combine for further processing, and the lower non-useful portion, e.g. the stalk, either remaining in the field or processed separately.

In further detail, the cutter or sickle bar assembly 10 may include a bar 12 with a blade 20 or series of blades attached. These blades 20 may be attached to the bar 12 using a nut 16 and bolt 14 combination. The sickle bar 10 may be attached at either end to a motor or motors that reciprocate the cutter 10 back and forth (side to side with respect to the motion of the combine). The top of the blades 20 of the cutters may be very close to the bottom of the fingers of the combine, trapping and shearing the stalks of the crops between the cutter 10 and the stationary fingers of the combine.

The sickle bar 10 may include a number of individually attached blades 20. The blades 20 include a number of teeth 22, which in the prior art may be of the single or two-tooth variety. There may be a pair of attachment holes 24 associated with each tooth 22 in the base of the blade 20 that allow for a solid connection to the bar 20 while also restricting rotational movement of the blade 22 about an axis, e.g. as would be allowed with a single nut 16 and bolt 14 arrangement.

The sickle bar 10 may be supported only at either end of the bar. When these types of bars were used in the past, it is believed that the bars 10 were about 20 feet long. Currently, the bars are believed to be up to about 60 feet in length. As longer and longer bars are used in order to harvest more crops per pass through the field, the stresses within the sickle bar 10 at unsupported areas of the bar increase.

This increased stress is not usually enough to break the cutter or sickle bar 10 in a single instance. However, repeated use over time may cause fatigue in the cutter 10 such that the bar 12 snaps or breaks, sometimes breaking within the first 24 hours of use. After the sickle bar 10 is broken, it then requires either a replacement, or it must be spliced in some fashion.

The sickle bar almost never fails at a point with a blade attached. This is for two main reasons. First, there is an increased constructive cross-sectional area of the sickle bar in areas with the solidly attached blade increasing the strength of the bar/blade combination in that area. Second, the movement of the bar in the areas where a single blade 20 is attached is severely restricted, mainly due to the increased constructive cross-section. In nearly every sickle bar fatigue failure, the break in the sickle bar 10 occurs between the blades as shown in FIG. 3. It is at this point between the bases of the blades 20 along the bar 12 where most of the internal relative movement of the bar 12, and as a result, most of the bar's internal stresses, occurs. For this reason, the bar 12 typically breaks between the blades 20, with the blades 20 on either side of the break in the bar 20 completely intact.

Previous methods of splicing the bar in the prior art include attaching a second bar, or an additional bar on both the top and bottom of the broken sickle bar. This additional splice bar is attached either over the entire length of the sickle bar, or only a length on either side of the broken portion. There are at least two problems with this method. First, because of the increased thickness of the stack, longer bolts 14 are needed to keep the assembly together. Second, and more importantly, the bar is very likely to fail again in the exact same spot because the stresses in that area are not removed or mitigated but simply shifted into the replacement bars, which are typically not as thick as the original bar 12.

Another method in the prior art to splice the sickle bar back into working order is to shift the two-tooth blades over by a single tooth. In this method, one tooth of the two-tooth blade 20 with two fasteners is placed on one side of the sickle bar break, and another tooth of the two-tooth blade 20 with two fasteners is placed on the other side of the sickle bar break. There are three main issues with this method. First, this too would be a simple temporary fix because while the area of the break is now reinforced, there is only a single tooth and a pair of fasteners on either side of the break, and the bar is very likely to break again on one side of the blade or the other. Second, this is a difficult and time-consuming fix, because all of the two-tooth blades on the bar need to shift one tooth position over, which also leaves at least one tooth position on either end of the bar 12 unoccupied. Third, if the sickle bar 10 breaks again in another position, this fix becomes untenable because the position of the first fix is unable to move one tooth position again as would be necessary in order to reposition all of the two-tooth blades to accommodate the break.

In an embodiment, a replacement blade 120 includes four teeth 122. The blade 120 may include base portion 128 that attaches to the bar 12. The base 128 may include two attachment holes 124 per tooth position on the bar, or a total of eight attachment holes 124. The attachment holes 124 may be lined up along an axis [symbol] of reciprocating movement of the sickle bar 10 while it is in use.

The teeth 122 of the blades 120 may extend generally in a direction perpendicular to the axis of movement. The teeth 122 may be triangular in shape, with a first side and a second side that extend from the base at an oblique angle to the axis of movement. The first and second sides may terminate at a point 130. The point 130 of the tooth 122 may also be blunted so as not include a sharp point to protrude out from the blade 120.

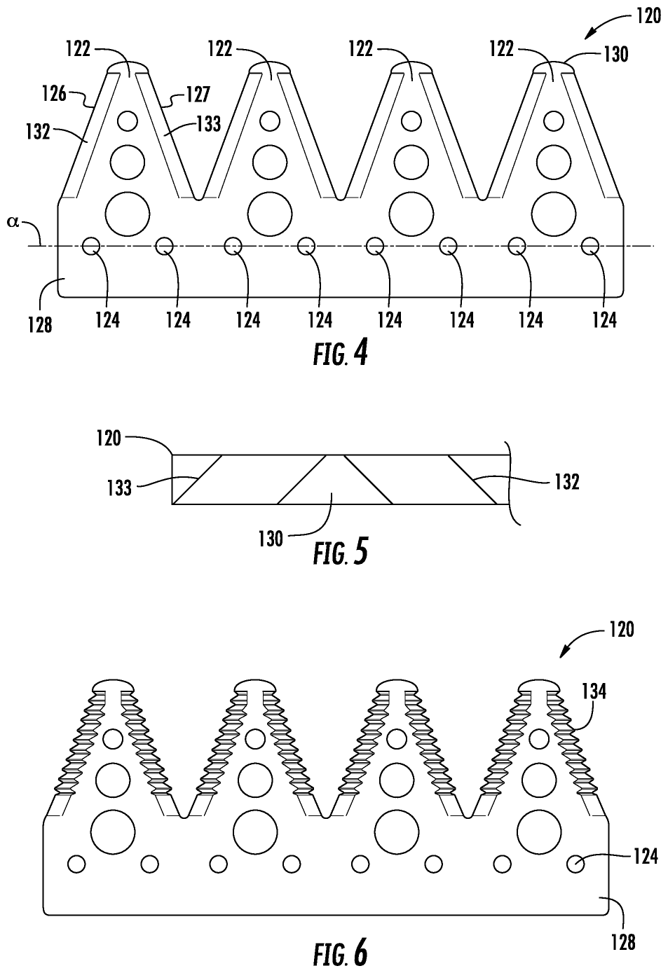

As shown in detail in FIG. 5 (note that FIG. 5 may not be to scale, but is rather shown to identify characteristics of the teeth 122), the first and second sides 126, 127 may include respective cutting surfaces 132, 133. The cutting surfaces 132, 133 may be on a plane that is oblique to the plane of the base 128 such that the teeth are wider on a bottom side and narrower on a top side of the tooth. The cutting surfaces 132, 133 may further include cutting edges 134 (see FIG. 6) that aid in the grabbing and shredding of the crops between the teeth 122 and the stationary fingers of the harvester.

The blade 120 is preferably between 1/16 and 3/16 inches in thickness, more preferably ⅛ inch in thickness. The blade 120 is preferably between 7½ and 8½ inches in length, more preferably between 7¾ and 8 inches in length, and most preferably about 7 15/16 in length.

In practice, if a sickle bar 10 with single or two-tooth blades 20 is broken or snapped between blade positions, the four-tooth blade 120 may be used as both a replacement for the attached blades and as a splice for the broken bar 12.

In the single-tooth replacement, the user may remove two of the single-tooth blades 20 from one side of the break, and two of the single-tooth blades 20 from the other side of the break. The replacement blade 120 is then placed on the bar 12 with two teeth 122 on one side of the break, and two teeth 122 on the other side of the break. In this way, no new hardware (nuts 16 and bolts 14) is needed, because the overall thickness of the sickle bar assembly 10 is the same as before. The stresses on the bar 12 from the area are spread out with a single blade 120 having four attachments (14, 16) on either side of the break in the bar 12 and extending at least two teeth 122 out from the break. No other blades 20 of the cutter 10 need to be removed, moved, or touched in any way, which allows for quick and easy replacement in the field by the user.

Similarly, in the two-tooth blade replacement, the user may remove one of the two-tooth blades 20 from one side of the break, and one of the two-tooth blades 20 from the other side of the break. The replacement blade 120 is then placed on the bar 12 with two teeth 122 on one side of the break, and two teeth 122 on the other side of the break. In this way, no new hardware is needed, because the overall thickness of the cutter assembly 10 is the same. The stresses on the bar 12 from the area are spread out with a single blade 120 having four attachments (14, 16) on either side of the break and extending at least two teeth 122 out from the break. No other blades 20 need to be removed, moved, or touched in any way, which allows for quick and easy replacement in the field by the user.

In another embodiment, a single replacement blade 120 includes 6 or 8 teeth 122. This will be used in a similar way on a broken sickle bar and still allows for a single replacement blade that splices the break and spreads out the stresses on the bar 12, while not requiring a shift of all of the other blades 20 on the sickle bar 10.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A replacement blade for a sickle bean harvester, comprising:
a base comprising a substantially flat sheet of metal and having an axis of movement and a base plane, the base configured to attach to a sickle bar in at least four blade positions; and
a series of four teeth extending from the base in a direction perpendicular to the axis of movement, each of the teeth comprising a triangular shape including a first side, second side, and a third side, wherein:
the first side extends in an oblique angle from the base, and comprises a first cutting surface on a first cutting plane that is oblique from the base plane, and comprises a first series of cutting edges within the first cutting surface;
the second side extends in an oblique angle from the base and meets the first side at a point, and comprises a second cutting surface on a second cutting plane that is oblique from the base plane, and comprises a second series of cutting edges within the second cutting surface; and
the third side is integral with and abuts the base.

2. The replacement blade of claim 1, wherein the point is blunted.

3. The replacement blade of claim 1, wherein the replacement blade is at least ⅛ inch in thickness.

4. The replacement blade of claim 1, wherein the replacement blade is at least 7¾ inches in length.

5. A cutting blade for attachment to an agricultural implement, comprising:
at least eight connection holes extending along a movement axis;
at least four cutting teeth, each cutting tooth comprising a first cutting surface and a second cutting surface, the first and second cutting surfaces extending at an angle from the movement axis and further comprising a plurality of cutting edges;
wherein the connection holes are configured to attach to sickle bar in at least four blade positions.

6. The cutting blade of claim 5, wherein the blade is at least ⅛ inches in thickness.

7. The cutting blade of claim 6, wherein the blade is at least 7¾ inches in length.

8. A method of repairing a sickle bar on an agricultural implement comprising the steps of:
removing a sickle bar comprising a plurality of two-tooth blades from an agricultural implement, the sickle bar being broken between two of the plurality of two-tooth blades;
removing a first two-tooth blade from a first side of a break in the sickle bar;
removing a second two-tooth blade from a second side of a break in the sickle bar;
rejoining the broken sickle bar by attaching a four-tooth blade to the sickle bar such that a first pair of teeth on the four-tooth blade are on the first side of the break in the sickle bar, and a second pair of teeth on the four-tooth blade are on the second side of the break in the sickle bar.

9. The method of claim 8, wherein the rejoining step includes the step of attaching the four-tooth blade using a set of screws and nuts through attachment holes in the four-tooth blade.

10. The method of claim 9, wherein a total of eight screws and eight nuts are threaded through eight attachment holes in the four-tooth blade.

11. The method of claim 10, wherein the eight screws and eight nuts are the same eight screws and eight nuts used to hold the first two-tooth blade and the second two-tooth blade to the sickle bar.
